(19) United States
(12) Patent Application Publication
(10) Pub. No.: US 2026/0352045 A1
(43) Pub. Date: Nov. 5, 2026

(54) ROTOR FOR AN ELECTRIC MACHINE, ELECTRIC MACHINE, AND METHOD FOR MANUFACTURING SUCH A ROTOR

(71) Applicant: Robert Bosch GmbH, Stuttgart (DE)

(72) Inventor: Stefan Marke, Buehl (DE)

(21) Appl. No.: 19/150,295

(22) PCT Filed: Jan. 23, 2024
(86) PCT No.: PCT/EP2024/051532

§ 371 Date: Jul. 23, 2025

(30) Foreign Application Priority Data
Feb. 1, 2023 (DE) 10 2023 200 806.8

(51) Int. Cl. H02K 1/278; H02K 1/276; H02K 15/035; H02K 15/121

(52) U.S. Cl. CPC H02K 1/278; H02K 1/276; H02K 15/035; H02K 15/121

(57) ABSTRACT

A rotor (10) for an electric machine (12), an electric machine (12), and a method for manufacturing such a rotor (10) comprising a main body (14), on the radially outer circumference (15) of which a plurality of rotor magnets (20) are arranged, wherein the rotor magnets (20) are fixed on the main body (14) by means of a rotor sleeve (30) made of metal, wherein the rotor sleeve (30) has limited thermally treated regions (32) which radially brace the rotor sleeve (30) on the main body (14).

### PRIOR ART

The invention relates to a rotor for an electric machine, as well as an electric machine, and a method for manufacturing such a rotor according to the independent claims.

DE 10 2007 029 719 A1 discloses a rotor of an electric machine, in which “buried magnets” are arranged in radially externally closed magnetic pockets of the rotor. The magnetic poles of the rotor are determined by the shape of the radial outer tangential rod, which terminates the magnetic pocket radially outwards. Thus, in that embodiment, the exact positioning of the magnets within the magnetic pocket in the tangential direction is relatively non-critical and does not have a large impact on the locking torque of the rotor.

CN 104659941 A discloses a further rotor, in which the magnets are positioned at the surface of the rotor main body by means of radial retaining bars. A band is glued onto the magnets and pressed against the curved peripheral surface of the magnets. In that embodiment, the assembly process for fastening the band is very cumbersome, since adhesive processes in the assembly line quickly lead to soiling. This disadvantage is to be rectified by the solution according to the invention.

### DISCLOSURE OF THE INVENTION

### Advantages of the Invention

The device according to the invention and the method according to the invention with the features of the independent claims have the advantage, that, by locally heating limited areas of the rotor sleeve after cooling it, a tensile residual stress of the sleeve material is created, which results in the rotor sleeve contracting radially. The rotor sleeve, which can previously have been pushed onto the rotor magnets with a loose fit, is thereby pressed radially against the rotor magnets after the thermally treated regions have been formed. This has the advantage that the rotor sleeve can be pushed onto the rotor magnets without pressing, which also means that no insertion phase is necessary at an axial end of the rotor sleeve. By omitting the insertion phase, the maximum outer diameter of the rotor sleeve can be reduced and/or reworking of the insertion phase is omitted. The limited regions of the rotor sleeve are preferably heated so much that the material of the rotor sleeve melts so that the shrinkage process of the rotor sleeve reduces the inner diameter of the rotor sleeve so much as to force the rotor magnets against the main body when the melted material hardens again, and they thereby remain securely fixed during operation of the electric machine.

The measures set out in the dependent claims allow for advantageous refinements and improvements of the embodiments specified in the independent claims. In order to reduce the inner diameter of the rotor sleeve as much as possible, the limited thermally treated regions are formed as heat seams that extend in the axial direction parallel to the rotor axis. If these heat seams extend substantially the entire axial length of the rotor sleeve, the inner diameter of the rotor sleeve is uniformly reduced over the entire axial length thereof, whereby the rotor sleeve conforms evenly to the surface of the rotor magnet.

In a preferred embodiment, the rotor magnets extend substantially over the axial extension of the rotor main body. The rotor sleeve also extends substantially over the entire axial length of the main body. In this embodiment, the axial heat seams are particularly advantageously formed in terms of the circumferential direction between two adjacent rotor magnets, so that the rotor magnets are not damaged when the sleeve material is heated. The axial heat seams are thus formed radially directly over the main body—or over the radial bars that are formed on the main body, wherein heating of the main body has no damaging effects.

To precisely position the rotor magnets on the main body, radial retaining bars are formed on the latter, on which the rotor magnets can be supported in the circumferential direction. Spring elements, which can compensate for manufacturing tolerances and temperature fluctuations, can also be formed particularly advantageously on the retaining bars. The radial retaining bars and/or the spring elements can particularly easily be punched directly out of sheet metal in a single piece. The radial extent of the radial bars is less than the maximum radial extent of the rotor magnets, since the rotor sleeve is radially fixed against the outer surface of the rotor magnets when reducing the diameter thereof.

The cross-section of the rotor magnets is particularly favorably shaped such that the radial peripheral surfaces are curved or circular. The radial inner surfaces of the magnets, on the other hand, are preferably configured as straight, flat surfaces that abut the planar contact surfaces of the rotor main body along the full surface. The cross section of the rotor magnets transverse to the axial direction is advantageously configured in the form of a “loaf of bread,” in which the curved radial outer surface is connected to the planar radial inner surface by means of two tangentially opposite lateral surfaces. Preferably, these lateral surfaces are approximately perpendicular to the base surface, but alternatively can also extend approximately in the radial direction to the main body. Two opposite lateral surfaces of two adjacent magnets can be supported in the tangential direction on the main body in order to reliably position and fix the rotor magnets with respect to the tangential direction. The rotor sleeve, at least with respect to the circumferential direction in the central region of the radial outer surface, rests against the rotor magnets in order to radially press the rotor magnets against the contact surfaces.

The rotor sleeve can be manufactured in a particularly simple and cost-efficient manner by means of a deep-drawing method. To this end, a metal sheet is used, the thickness of which material is selected such that the desired rapid shrinkage of the rotor sleeve is produced upon cooling the locally limited thermally treated regions. Likewise, the material of the rotor sleeve can be selected accordingly in order to achieve sufficient shrinkage of its inner diameter. For example, the rotor sleeve may be made from steel or aluminum, but in particular from a magnetically non-conductive metal.

In order to save weight and for optimal magnetic flux of the rotor, the rotor main body advantageously comprises radial bars that extend radially from a central hub to an outer yoke ring. The hub can be pushed onto the rotor shaft-preferably pressed on. On the outer circumference of the yoke ring, the-in particular planar-contact surfaces for the rotor magnets are formed. At the tangential regions between two adjacent rotor magnets, the radial retaining bars are arranged, which preferably lie in the peripheral regions of the radial bars.

The rotor according to the invention is particularly suitable for use in an electrically commutated EC motor in which the rotor is configured as an internal rotor motor. The rotor is arranged within a stator, in which an electrical winding is arranged within a stator housing, which is electronically commutable. By means of the rotor sleeve according to the invention, the rotor magnets remain reliably positioned on the rotor and are protected from spinning and flying out.

To assemble the rotor according to the invention, the rotor sleeve is pushed onto the rotor in the axial direction in a cold state, on the main body of which the rotor magnets have previously been positioned. Thereafter, in the locally limited regions of the rotor sleeve, the material is heated by means of an external heat source to such a degree that upon cooling of these locally limited regions, the material of the rotor sleeve contracts in these areas. Due to the corresponding arrangement of the locally limited thermally treated regions, a residual stress due to shrinkage can thus be produced upon cooling in the locally limited regions, which presses the rotor sleeve radially against the rotor magnets.

Particularly favorably, the material of the limited areas may be heated very precisely with the help of a laser beam, and in particular may be melted. The laser beam may be guided with many degrees of freedom along the surface of the rotor sleeve in order to form appropriately formed thermally treated regions. The applied energy and the focus of the laser beam can be adjusted to the sleeve material and the material thickness of the rotor sleeve, respectively.

It is particularly advantageous if the laser beam is guided in the axial direction preferably over the entire axial length of the rotor sleeve in order to form axial heat seams on it. Preferably, these heat seams are formed in terms of the circumferential direction between two rotor magnets, wherein, for example, an axial thermal seam is formed between each of the rotor magnets. In particular, residual stress due to shrinkage can be produced in the tangential direction between the rotor magnets, which makes the inner diameter of the rotor sleeve shrink more at these locations than in the area of the maximum radial extension of the rotor magnets.

With these assembly methods, the rotor sleeve can particularly easily be formed without an insertion phase, since the rotor sleeve can be pushed onto the radial outer surfaces of the rotor magnets with a loose fit. By omitting the insertion phase, the rotor has a smaller outer diameter after the finished assembly, and/or material processing of the insertion phase after the rotor sleeve has been pushed on, can be omitted. In contrast to the usual shrink pressing of a sleeve, circumferential stresses can be produced subsequently after pushing it on, so that, on the one hand, the rotor sleeve can be pushed onto the rotor magnets with a loose fit, and, on the other hand, a sufficient radial pressing force can be produced on the rotor magnets by locally melting the rotor sleeve. The extent of the radial pressing force of the rotor sleeve can be influenced by the number and the length of the thermal seams. Since the rotor magnets are preferably already radially magnetized, they are retained on the contact surfaces of the rotor main body upon pushing on the rotor sleeve by the magnetic force. The melting of the material of the rotor sleeve by means of a laser beam does not impair the magnetic properties of the rotor magnets.

In an alternative embodiment, the locally limited regions of the rotor sleeve can be heated inductively, for example, wherein a plurality of limited thermally treated areas can simultaneously be produced on the rotor sleeve. The power of the inductive heater can be set so high that the corresponding material of the rotor sleeve is melted.

### BRIEF DESCRIPTION OF THE DRAWINGS

Exemplary embodiments of the invention are shown in the drawings and explained in more detail in the following description.

The following is shown:

FIG. 1 a sectional view of a first exemplary embodiment of a rotor according to the invention in a longitudinal section,

FIG. 2 a side view of the embodiment according to FIG. 1, and

FIG. 3 a further embodiment of a rotor in an electric machine in a cross-section.

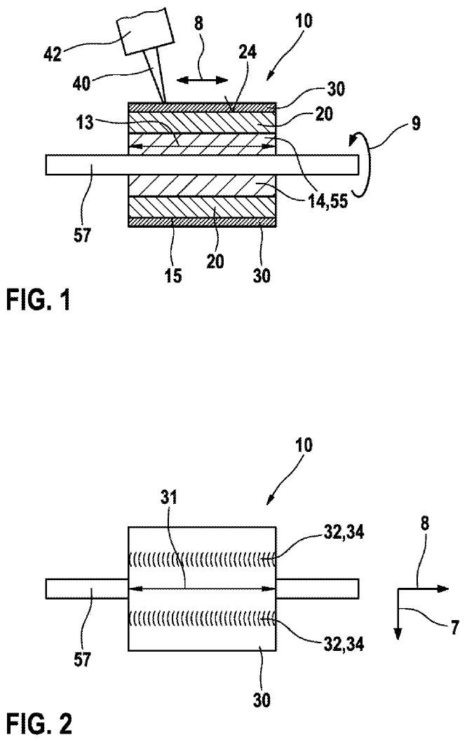

In FIG. 1, a rotor 10 of an electric machine 12 is shown, which has a main body 14 on which contact surfaces 16 are formed on the outer circumference 15. Rotor magnets 20 are arranged on the contact surfaces 16, which preferably extend over the entire axial length 13 of the main body 14. The rotor magnets 20 are formed in an arch shape in the circumferential direction 9 and have an inner base surface 26 and a radial outer surface 24. A rotor sleeve 30 abuts the radial outer surfaces 24, which serves as a spinner for the rotor magnets 20. The rotor sleeve 30 is made of a metal sheet, for example, in particular by means of a deep drawing method. For assembly, the rotor sleeve 30 is first pushed on in the axial direction 8 with a loose fit on the radial outer surfaces 24 of the rotor magnets 20. Thereafter, localized areas 32 are thermally treated to contract upon cooling and produce a tensile residual stress. As a result, the inner diameter 29 of the rotor sleeve 30 is reduced, thereby pressing the rotor sleeve 30 in the radial direction 7 against the radial outer surface 24 of the rotor magnets 20. As a result, the rotor magnets 20 are pressed against the contact surfaces 16 of the main body 14 at their base surface 26. As a result, the rotor magnets 20 can be securely fixed to the main body 14 without the need to push the rotor sleeve 30 onto the rotor magnets 20 by means of a tight fit. In FIG. 1, a laser beam 40 is used as a heat source 42 for the thermal treatment of the limited regions 32, by means of which the limited areas 32 are preferably melted. If the laser beam 40 is guided from the outside over the rotor sleeve 30, so-called heat seams 34 are formed on it, which preferably extend in the axial direction 8 of the rotor sleeve 30.

Distributed throughout the circumference, a plurality of heat seams 34 are formed as limited thermally treated regions 32, such as that depicted in FIG. 2. Preferably, the thermal seams 34 extend over the axial length 31 of the rotor sleeve 30. The number of these heat seams 34 can affect the radial pressing force, with which the rotor sleeve 30 pushes onto the rotor magnets 20.

For example, the heat seams 34 are each formed with respect to the circumferential direction 9 between two rotor magnets 20.

This may prevent the magnetic material of the rotor magnets 20 from being compromised during the thermal treatment of the rotor sleeve 30.

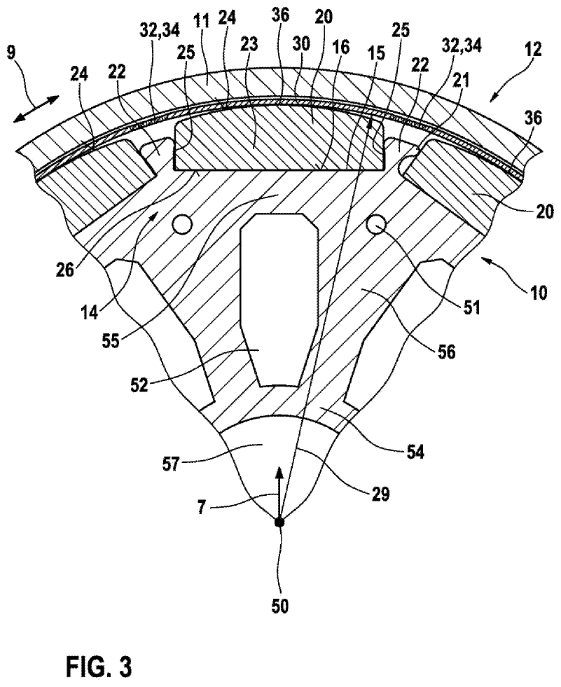

In FIG. 3, a cross-section through an electric machine 12 is shown as a further exemplary embodiment. The rotor 10 is arranged within a stator 11, which preferably comprises an electrically commutable winding, which cooperates with the rotor magnets 20 of the rotor 10. The rotor body 14 here has a hub 54 arranged on the rotor shaft 57. Radial bars 56 extend radially outward from the hub 54 to a yoke ring 55 closed in the circumferential direction 9. Cutouts 52 are formed between the radial bars 56 that reduce the weight of the rotor 10. The main body 14 can be assembled, for example, from individual sheets of metal that are arranged axially above each other and connected to each other-in particular by means of packet punching 51. On the outer circumference 15 of the yoke ring 55, the contact surfaces 16 for the rotor magnets 20 are configured as flat surfaces in the circumferential direction 9. The planar base surface 26 of the rotor magnet 20 rests against this planar contact surface 16. The rotor magnet 20 preferably has a cross-section 23 “shaped like a loaf of bread,” wherein lateral surfaces 25 are formed between a curved radial outer surface 24 and the planar inner base surface 26. In the circumferential direction 9, radial retaining bars 22 are formed on the main body 14 between the rotor magnets 20. These radial retaining bars 22 are used for correct positioning of the rotor magnets 20 and can optionally also be designed as spring elements 21, which fix the rotor magnets 20 between the retaining bars 22 in the circumferential direction 9. The rotor magnets 20 are preferably magnetized in the radial direction 7, wherein adjacent rotor magnets 20 then form opposite magnetic poles. The yoke ring 55 serves as a magnetic return path between two adjacent rotor magnets 20. In the embodiment shown in FIG. 3, the curvature of the radial outer surface 24 of the rotor magnets 20 deviates from a circular ring about the center point 50 of the rotor 10. The radial extension of the radial retaining bars 22 is less than the radial extension of the lateral surfaces 25 of the rotor magnets 20. If the limited thermally treated regions 32 are now formed tangentially between the rotor magnets 20 after axially sliding on the rotor sleeve 30, these generate a residual stress due to shrinkage that presses the rotor sleeve 30 in the radial direction 7 against the rotor magnets 20. In this case, the rotor sleeve 30 rests against the rotor magnet 20 radially in the area of the curved radial outer surfaces 24. In the tangential circumferential area between two adjacent rotor magnets 20, the limited thermally treated areas 32 of the rotor sleeve 30 have a radial distance from the radial retaining bars 22. Due to the residual stress due to shrinkage of the thermally treated regions 32, the rotor sleeve 30 radially conforms to the surface of the rotor 10, whereby the rotor sleeve 30 in particular deviates from an exact circular shape around the center point 50 after the thermal treatment thereof. The limited thermally treated regions 32 are also preferably formed here as axial heat seams 34 that extend along the lateral surfaces 25 of the rotor magnets 20 in the axial direction 8. The material of the rotor sleeve 30 is preferably magnetically non-conductive so that the magnetic field lines of the rotor poles of the rotor magnets 20 extend radially outwards towards the stator 11. An air gap is formed between the outer circumference of the rotor sleeve 30 and the stator 11 so that the rotor 10 can rotate unhindered within the stator 11. Preferably, an axial heat seam 34 is formed between all rotor magnets 20, wherein, for example, the rotor 10 comprises six or ten or twelve or eighteen rotor magnets 20, which substantially extend over the entire axial extension 13 of the main body 14. For example, the electric machine 12 is configured as an electrically commutated EC motor having an output element arranged on the rotor shaft 57. The rotor magnets 20 remain securely fixed to the main body 14 by the rotor sleeve 30, even if the rotor magnets 20 are damaged during operation.

It should be noted that with regard to the exemplary embodiments shown in the figures and in the description, a wide variety of possible combinations of the individual features with one another is possible. For example, the specific configuration and arrangement of the contact surfaces 16 and the rotor magnets 20 may be varied. For example, the rotor magnets 20 may also be cup shaped or cub shaped instead of in the shape of a loaf of bread in the cross-section. Likewise, the specific configuration, as well as the number of radial retaining bars 22, can be adjusted to the requirements of the electric machine 12. The deformability—and thus the pressing forces generated thereby—of the rotor sleeve 30 can be adjusted by the material used and its wall thickness and by the number and length of the limited thermally treated regions 32. As an alternative heat source 42, the thermally treated regions 32 can also be generated by means of inductive heating, during which in particular a plurality of heat seams 34 can be formed simultaneously. The invention is particularly suitable for use in an EC motor configured with an internal rotor, especially for the rotary drive of components or the adjustment of parts in motor vehicles, but is not limited to these applications.

1. A rotor (10) for an electric machine (12), the rotor (10) comprising: a main body (14), on a radially outer circumference (15) of which a plurality of rotor magnets (20) are arranged, wherein the rotor magnets (20) are fixed on the main body (14) by a rotor sleeve (30) made of metal, wherein the rotor sleeve (30) has limited thermally treated regions (32) which radially brace the rotor sleeve (30) on the main body (14).

2. The rotor (10) according to claim 1, wherein the limited thermally treated regions (32) are formed as axial heat seams (34).

3. The rotor (10) according to claim 1, wherein the rotor magnets (20) extend substantially over an entire axial length (13) of the main body (14) and the axial heat seams (34) are arranged in a circumferential direction (9) between two adjacent rotor magnets (20).

4. The rotor (10) according to claim 1, wherein radial retaining bars (22) for the rotor magnets (20) are formed in a circumferential direction (9) between planar contact surfaces (16) for the rotor magnets (20) on the main body (14), opposite lateral surfaces (25) of the radial retaining bars (22) rest against two adjacent rotor magnets (20).

5. The rotor (10) according to claim 1, wherein the rotor magnets (20) have a cross-section (23) shaped like a loaf of bread and each has a base surface (26) that rests flat against contact surfaces (16) of the main body (14), and a radial outer surface (24) is formed in a curved manner, against which arc-shaped sections (36) of the rotor sleeve (30) rest radially, and the rotor magnets (20) radially press against the contact surfaces (16).

6. The rotor (10) according to claim 1, wherein the rotor sleeve (30) is manufactured in a circumferential direction (9) as an uninterrupted ring.

7. The rotor (10) according to claim 1, wherein the main body (14) comprises a central hub (54) pressed onto a rotor shaft (57) and a circumferential yoke ring (55), on the external side of which contact surfaces (16) for the rotor magnets (20) are formed.

8. An electric machine (12) comprising a rotor (10) according to claim 1, which is arranged such that the rotor (10) rotates within a stator (11) comprising an electronically commutated winding.

9. A method for manufacturing a rotor (10) for an electric machine (12) according to claim 1, comprising the steps of:
axially sliding the rotor sleeve (30) over the rotor magnets (20);
locally heating the rotor sleeve (30) to form the limited thermally treated regions (32);
cooling the rotor sleeve (30), wherein the limited thermally treated regions (32) generate a residual stress from shrinkage, which the rotor magnets (20) press against contact surfaces (16) of the main body (14) in a radial direction (8).

10. The method according to claim 9, wherein the limited thermally treated regions (32) are heated by a laser beam (40).

11. The method according to claim 10, wherein the laser beam (40) is guided radially from an outside along an axial extension (31) of the rotor sleeve (30) to form axial heat seams (34).

12. The method according to claim 9, wherein the rotor sleeve (30) is pushed onto the rotor magnets (20) without an insertion phase with a loose fit, and a tight fit between the rotor sleeve (30) and the rotor magnets (20) only forms after thermally treated areas of the rotor sleeve (30) are heated locally.

13. The method according to claim 9, wherein the limited thermally treated regions (32) are heated by inductive heating.

14. The rotor according to claim 2, wherein the axial heat seams (34) extend over an entire axial length (31) of the rotor sleeve (30).

15. The rotor (10) according to claim 6, wherein the rotor sleeve (30) is manufactured by deep drawing.

16. The rotor (10) according to claim 7, wherein the contact surfaces (16) extend between the hub (54) and the yoke ring (55) and a radial bar (56).

17. The method according to claim 10, wherein the limited thermally treated regions (32) are melted locally by the laser beam (40).

18. The method according to claim 13, wherein the inductive heating heats a plurality of thermally treated regions (32) simultaneously.
